(19) United States
(12) Patent Application Publication
(10) Pub. No.: US 2019/0346944 A1
(43) Pub. Date: Nov. 14, 2019

(54) INTEGRATED ACTIVE MATRIX TOUCH PANEL WITH AMPLIFICATION

(71) Applicant: Sharp Kabushiki Kaisha, Osaka (JP)

(72) Inventors: Diego Gallardo, Oxford (GB); Christopher James Brown, Oxford (GB)

(21) Appl. No.: 15/975,815

(22) Filed: May 10, 2018

(51) Int. Cl. G06F 3/044; G06F 3/041; G02F 1/1362; G02F 1/1333; G09G 3/3233

(52) U.S. Cl. CPC G06F 3/044; G06F 3/0412; G09G 3/3233; G02F 1/1362; G02F 1/13338; G06F 3/0416

(57) ABSTRACT

A touch panel includes a plurality of touch panel elements that are operable in a sense mode and a function mode, each touch panel element comprising an array of unit cells. Each unit cell includes: a pixel array including a plurality of pixels arranged in rows and columns; a first transistor M1 that is connected at a first M1 terminal to a sense line (SEN) and at a gate of the first transistor to a first select line (SEL); a second transistor M2 that is connected at a first M2 terminal to a function line (FNC) and at a gate of the second transistor to a second select line (SELB); and amplifier circuitry that is integrated into the unit cell. During a function mode the second transistor is placed in an on state by a control signal from the SELB line to electrically connect the unit cell to the FNC line, and the first transistor is in an off state to electrically disconnect the first transistor from the SEN line. During the sense mode the first transistor is placed in an on state by a control signal from the SEL line to electrically connect the unit cell to the SEN line, and the second transistor is in an off state to electrically disconnect the second transistor from the FNC line; and the amplifier circuitry amplifies a sense signal that flows through the first transistor to the SEN line when the unit cell is in the sense mode.

### TECHNICAL FIELD

The present invention relates to touch panel devices, and capacitive type touch panel devices in particular. Such capacitive type touch panel devices may find application in a range of consumer electronic products including, for example, mobile phones, tablet, laptop and desktop PCs, electronic book readers and digital signage products.

### BACKGROUND ART

Touch panels have become widely adopted as the input device for a range of electronic products such as smart-phones, tablet devices, and computers. Most high-end portable and handheld electronic devices now include touch panels. These are most often used as part of a touchscreen, i.e., a display and a touch panel that are aligned so that the touch zones of the touch panel correspond with display zones of the display.

The most common user interface for electronic devices with touchscreens is an image on the display, the image having points that appear interactive. For example, the device may display a picture of a button, and the user can then interact with the device by touching, pressing or swiping the button with a finger or with a stylus. For example, the user can “press” the button and the touch panel detects the touch (or touches). In response to the detected touch or touches, the electronic device carries out some appropriate function. For example, the electronic device may turn itself off, execute an application, perform some manipulation operation, and the like.

Although, a number of different technologies can be used to create touch panels, capacitive systems have proven to be the most popular due to their accuracy, durability, and ability to detect touch input events with little or no activation force. A basic method of capacitive sensing for touch panels is the surface capacitive method—also known as self-capacitance—for example as disclosed in U.S. Pat. No. 4,293,734 (Pepper, issued Oct. 6, 1981). A conventional implementation of a surface capacitance type touch panel is illustrated in FIG. 1, which includes a transparent substrate 10, the surface of which is coated with a conductive material that forms a sensing electrode 11. One or more voltage sources 12 are connected to the sensing electrode, for example at each corner, and are used to generate an electrostatic field above the substrate. When an input object 13 that is electrically conductive—such as a human finger—comes into close proximity to the sensing electrode, a capacitor 14 is dynamically formed between the sensing electrode 11 and the input object 13 and this field is disturbed. The capacitor 14 causes a change in the amount of current drawn from the voltage sources 12 wherein the magnitude of current change is related to the distance between the finger location and the point at which the voltage source is connected to the sensing electrode. Current sensors 15 are provided to measure the current drawn from each voltage source 12, and the location of the touch input event is calculated by comparing the magnitude of the current measured at each source. Although simple in construction and operation, surface capacitive type touch panels are unable to detect multiple simultaneous touch input events as occurs when, for example, two or more fingers are in contact with the touch panel.

Another well-known method of capacitive sensing applied to touch panels is the projected capacitive method—also known as mutual capacitance. In this method, as shown in FIG. 2, a drive electrode 20 and sense electrode 21 are formed on a transparent substrate (not shown). A changing voltage or excitation signal is applied to the drive electrode 20 from a voltage source 22. A signal is then generated on the adjacent sense electrode 21 by capacitive coupling via the mutual coupling capacitor 23 formed between the drive electrode 20 and sense electrode 21. A current measurement device 24 is connected to the sense electrode 21 and provides a measurement of the size of the mutual coupling capacitor 23. When the input object 13 is brought to close proximity to both electrodes, it forms a first dynamic capacitor to the drive electrode 27 and a second dynamic capacitor to the sense electrode 28. If the input object is connected to ground, as is the case for example of a human finger connected to a human body, the effect of these dynamically formed capacitances is manifested as a reduction of the amount of capacitive coupling in between the drive and sense electrodes, and hence a reduction in the magnitude of the signal measured by the current measurement device 24 attached to the sense electrode 21.

As described, for example, in U.S. Pat. No. 5,841,078 (Bisset et al, issued Oct. 30, 1996), by arranging a plurality of drive and sense electrodes in a grid pattern to form an electrode array, this projected capacitance sensing method may be used to form a touch panel device. An advantage of the projected capacitance sensing method over the surface capacitance method is that multiple simultaneous touch input events may be detected.

Devices have been disclosed in which the touch panel can switch between self-capacitive and projected or mutual capacitive modes by means of switches. For example, US 2014/0078096 (Tan et al., published Mar. 20, 2014) applies a method to fixed touch panel patterns. The objective of this capability is to use either mode when it is more beneficial for object detection. Moreover, some devices allow the change of shape or size of the sense and drive electrodes, or their spatial arrangements. For example, U.S. Pat. No. 8,054,300 (Berstein, issued Nov. 8, 2011) proposes a method of reconfigurability by means of switches located on the side of the panel or in a separate board.

In many touchscreens the touch panel is a device independent of the display. The touch panel sits on top of the display, and the light generated by the display crosses the touch panel, with an amount of light being absorbed by the touch panel. In more recent implementations, for example U.S. Pat. No. 7,859,521 (Hotelling et al., issued Dec. 28, 2010), part of the touch panel is integrated within the display stack, and the touch panel and display may share the use of certain structures, such as transparent electrodes. This integration of the touch panel into the display structure seeks to reduce price by simplifying manufacture, as well as reducing the loss of light throughput that occurs when the touch panel is independent of the display and located on top of the display stack.

Another fully integrated touch panel is described in U.S. Pat. No. 8,390,582 (Hotelling et al., issued Mar. 5, 2013). The disclosed device uses additional signal lines and transistors to switch between display functionality and self-capacitance touch panel functionality, requiring at least three additional transistors per pixel. Display RGB data lines are connected to source/drain transistor terminals, and act as either voltage drive lines or charge sense lines, which prevents the concurrent driving of touch panel and display.

An enhanced integrated active matrix touch panel is disclosed in Applicant's commonly owned PCT publication number WO 2017/056500 (Gallardo et al., published Apr. 6, 2017), which is incorporated here by reference. As an integrated touch panel, the device is operable in either one of a self-capacitance touch sensing mode or a mutual capacitance touch sensing mode. The device includes both a display and a touch panel, and so is operable both as display and as a touch panel (although not necessarily simultaneously). The device is integrated in the sense that at least some components are common to both the touch panel and the display.

As described in WO 2017/056500, an active matrix touch panel (AMTP) is an in-cell technology by which all the components of the touch panel are integrated into the same substrate as the display circuitry, with which the touch panel shares space. In-cell or integrated touch panels save cost to the display manufacturer. In-cell touch panels, however, pose new problems, as normally the available space is very limited. Frequently, some components have to be shared between the display and touch panel components. For AMTP, the touch panel and the displays share the top electrode, also referred to as the common electrode or VCOM.

FIG. 3 is a drawing depicting an overview of an exemplary pixel arrangement 30 in a typical display system. The pixel arrangement 30 may include individual pixels 32 that are grouped into touch panel (TP) elements 34 that permit the touch panel operations described above. In a typical display, each pixel has a top electrode, and the pixel top electrodes combine into a single, continuous top electrode corresponding to VCOM as referenced above. For AMTP, the VCOM is patterned into a two-dimension array of touch panel elements 34. Each touch panel element covers a number of pixels, and the top electrode of these pixels is a component of the respective touch panel element. In this manner, therefore, the display and touch panel share the VCOM electrode.

FIG. 4 is a drawing depicting an exemplary AMTP structure comparably as taught in WO 2017/056500. In such configuration, a basic unit cell 36 includes a plurality of the individual pixels 32 arranged in an array. In this example, a basic unit cell 36 includes a 3×2 pixel array. The touch panel element 34 in turn includes an array of unit cells 36 arranged in parallel. A typical example may incorporate 100 unit cells 36 within a touch panel element 34, resulting in 600 individual pixels per touch panel element.

FIG. 5 is a drawing depicting an exemplary array 38 of touch panel elements 34, as may be incorporated into a touch panel display system. An exemplary electrical interconnection of the touch panel elements is shown in this figure. Each touch panel element can be connected either to a sense line (SEN) or to a function line (FNC). These connections are made by two thin film transistors (TFTs), denoted M1 and M2. Gate select lines SEL and SELB are operable to switch M1 versus M2 open or closed, thereby controlling whether the touch panel is electrically connected to SEN (via operation of the SEL gate line) or to FNC (via operation of the SELB gate line). The SEN lines connect to the sensing circuitry of a touch panel controller (TPC), so that touch signals can be read and measured. The FNC lines can either supply a driving signal from a display driver, or can be connected to ground for performing different functions of the pixels.

FIG. 6 is a drawing depicting an exemplary configuration of a unit cell 36, including electrical interconnections comparably as depicted in FIG. 5. The unit cell 36 employs the 3×2 pixel configuration referenced above, with FIG. 6 further illustrating the color sub-pixels red, blue, and green for each individual pixel 32 along with the respective interconnection lines. RGB TFTs are connected to a display gate line for control of light emission from the various sub-pixels via the RGB TFTs associate with the color sub-pixels. The M1 and M2 TFTs for this unit cell also are shown, as connected to the select, sense, and function lines as referenced above with respect to FIG. 5. In the dominant display technologies, the available space for touch panel TFTs and connection lines is very limited. For example, in LCDs most of the display area needs to be dedicated to the optical aperture for letting light through from the light source at the non-viewing side of the display system. In OLEDs and QLEDs, the backplane is usually crowded with driving and current compensation circuitry. The available space is fragmented, and typically is configured of small spaces in the vicinity of the RGB TFTs. A single TFT potentially could be used to switch each pixel, but such a configuration may be too resistive for a touch panel element. Accordingly, to form the touch panel element multiple unit cells are connected in parallel, with, as referenced above, the basic AMTP unit cell including six pixels arranged in an array of three rows by two columns. The basic unit cell configuration can be modified, for example to include additional TFTs for added functionalities. WO 2017/056500 describes several embodiments with modified unit cells, allowing different drive and sense schemes.

### SUMMARY OF INVENTION

The present disclosure describes enhancements to the unit cell of an active matrix touch panel (AMTP), such as the AMTP configuration described in WO 2017/056500. The enhanced unit cell includes integrated amplifier circuitry that amplifies touch signals received by the touch panel element in-situ, i.e., the amplifier circuitry is integrated into the touch panel itself such that touch signals are amplified within the unit cell before transmission to the touch panel controller. This integrated amplification improves the signal-to-noise ratio (SNR). In exemplary embodiments, the amplifier circuitry includes a capacitor and an additional TFT added to the unit cell circuitry. Such additional components may be incorporated into the unit cell circuitry without having to add any additional signal control lines.

An aspect of the invention, therefore, is an enhanced touch panel having integrated amplifier circuitry for amplifying sense signals that are read during a sense mode. In exemplary embodiments, a touch panel includes a plurality of touch panel elements that are operable in a sense mode and a function mode, each touch panel element comprising an array of unit cells; wherein each unit cell comprises: a pixel array including a plurality of pixels arranged in rows and columns; a first transistor M1 that is connected at a first M1 terminal to a sense line (SEN) and at a gate of the first transistor to a first select line (SEL); a second transistor M2 that is connected at a first M2 terminal to a function line (FNC) and at a gate of the second transistor to a second select line (SELB); and amplifier circuitry that is integrated into the unit cell. During a function mode the second transistor is placed in an on state by a control signal from the SELB line to electrically connect the unit cell to the FNC line, and the first transistor is in an off state to electrically disconnect the first transistor from the SEN line. During the sense mode the first transistor is placed in an on state by a control signal from the SEL line to electrically connect the unit cell to the SEN line, and the second transistor is in an off state to electrically disconnect the second transistor from the FNC line; and the amplifier circuitry amplifies a sense signal that flows through the first transistor to the SEN line when the unit cell is in the sense mode.

In exemplary embodiments, the amplifier circuitry includes a third transistor M3 and at least one capacitor that are integrated into the unit cell. A first plate of the capacitor is connected to the FNC line and a second plate of the capacitor is connected to a gate of the third transistor M3, wherein a potential at the gate of the third transistor M3 is determined by a potential divider formed by the capacitor and a capacitance of an object being sensed by the touch panel. The second plate of the capacitor and the gate of the third transistor meet at a common node with a second M2 terminal of the second transistor M2. A first M3 terminal of the third transistor M3 is connected to the gate of the first transistor M1 and the SEL line, and a second M3 terminal of the third transistor M3 is connected to a second M1 terminal of the first transistor M1 such that a sense signal modulated by the gate potential of the third transistor M3 flows through the first transistor M1 to the SEN line.

Another aspect of the invention is a method of operating a touch panel having integrated amplifier circuitry within the touch panel elements for amplifying a sense signal in-situ within the touch panel. In exemplary embodiments, the method includes the steps of: providing a touch panel including a plurality of touch panel elements that are operable in a sense mode and a function mode, each touch panel element comprising an array of unit cells that include amplifier circuitry integrated into each unit cell; operating a first portion of the touch panel elements in a function mode by electrically connecting said first portion of the touch panel elements to a function line FNC; operating a second portion of the touch panel elements in a sense mode by electrically connecting said second portion of the touch panel elements to a sense line SEN, wherein sense signals are read from the SEN line to detect a presence or absence of an object being sensed that operates the touch panel; and switching touch panel elements between being in the first portion of the touch panel elements operating in the function mode and the second portion of the touch panel elements operating in the sense mode to read sense signals across the touch panel; wherein the amplifier circuitry amplifies sense signals that flow to the SEN line from the second portion of touch panel elements that are operating in the sense mode.

In exemplary embodiments, the touch panel may be operated in a mutual capacitance mode whereby a first portion of touch panel elements is driven in the function mode, while the second portion of touch panel elements is operating in the sense mode. The touch panel further may be operated in a self-capacitance mode including the steps of: first operating all touch panel elements in the function mode to bring the common electrode to a set voltage for all touch panel elements; and after, sequentially operating the touch panel elements in the sense mode to read the sense signals from the touch panel elements until sense signals are read for the entire touch panel. The touch panel may be switched between operating the touch panel in the mutual capacitance mode and the self-capacitance mode.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a drawing depicting a conventional implementation of a surface capacitance type touch panel.

FIG. 2 is a drawing depicting a conventional implementation of a mutual capacitance type touch panel.

FIG. 3 is a drawing depicting an overview of an exemplary pixel arrangement in a typical display system.

FIG. 4 is a drawing depicting an exemplary active matrix touch panel configuration comparably as taught in WO 2017/056500.

FIG. 5 is a drawing depicting an exemplary array of touch panel elements as may be incorporated into a touch panel display system.

FIG. 6 is a drawing depicting an exemplary unit cell, including electrical interconnections comparably as depicted in FIG. 5.

FIG. 7 is a drawing depicting a sectional view of an exemplary touch screen device for an LCD display.

FIG. 8 is a drawing depicting a sectional view of an exemplary touch screen device having an integrated touch and display layer for an LCD display.

FIG. 9 is a drawing depicting control circuitry for a unit cell of a touch panel element, including amplifier circuitry in accordance with embodiments of the present invention.

FIG. 10 is a drawing depicting a plurality of unit cells each generally having the configuration of FIG. 9, and further illustrating operation in a mutual capacitance mode.

FIG. 11 is a drawing depicting functionality for implementing function and sense mode within an active matrix touch panel.

FIG. 12 is a drawing depicting alternative functionality for implementing function and sense modes within an active matrix touch panel.

FIG. 13 is a drawing depicting a unit cell generally having the configuration of FIG. 9, and further illustrating operation in a self-capacitance mode.

FIG. 14 is a drawing depicting an exemplary implementation of a unit cell in combination with associated pixel elements.

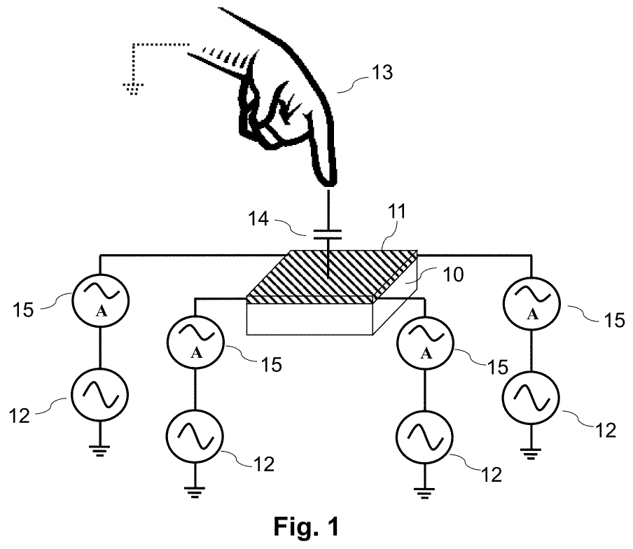

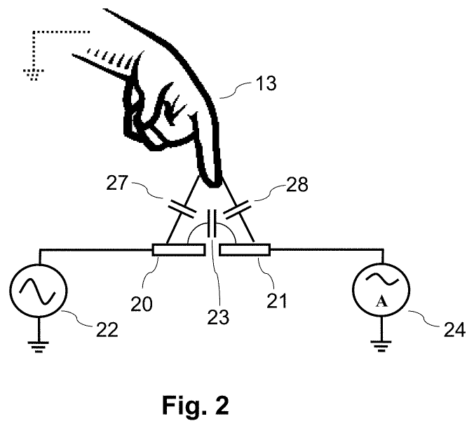

### DESCRIPTION OF EMBODIMENTS

Embodiments of the present invention will now be described with reference to the drawings, wherein like reference numerals are used to refer to like elements throughout. It will be understood that the figures are not necessarily to scale.

The present disclosure describes enhancements to the unit cell of an active matrix touch panel (AMTP) such as the AMTP configuration described in WO 2017/056500. The enhanced unit cell includes integrated amplifier circuitry that amplifies touch signals received by the touch panel element in-situ, i.e., the amplifier circuitry is integrated into the touch panel element itself such that touch signals are amplified within the unit cell before transmission to the touch panel controller. This integrated amplification improves the signal-to-noise ratio (SNR). In exemplary embodiments, the amplifier circuitry includes a capacitor and an additional TFT added to the unit cell circuitry. Such additional components may be incorporated into the unit cell circuitry without having to add any additional signal control lines.

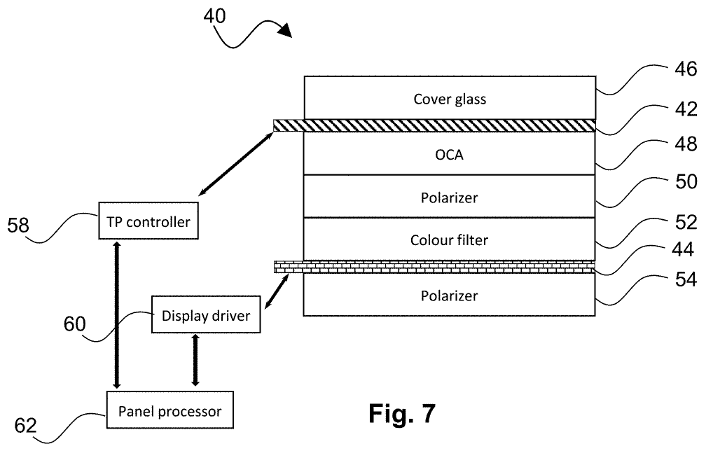

The present disclosure provides for an active matrix touch panel (AMTP) that may be used, for example, in touch panel display systems or the like. FIG. 7 is a drawing depicting a sectional view of an exemplary touch screen 40 for an LCD display, i.e. a combination of a touch panel 42 and a display 44. In the configuration of FIG. 7, the touch panel 42 and display 44 are physically separated, and typically the touch panel 42 may be located below a cover glass 46. Additional layer components may be incorporated into the display system stack, although the order, arrangement, and types of the layers may be different in different LCD configurations. For example, the components may include an optically clear adhesive (OCA) layer 48 that adheres the touch panel 42 to a front polarizer 50. The components further may include a color filter 52 on a viewing side of the display 44 to enhance color control, and a rear polarizer 54 on a non-viewing side of the display 44 relative to the front polarizer 50. A touch panel controller 58 generates control signals for operation of the touch panel functionality and reads sense signals generated by the touch panel during a sense mode. A display driver 60 generates control signals for function modes including various display functionalities. The touch panel controller 58 and display driver 60 both may be controlled and coordinated in turn by a main panel processor 62.

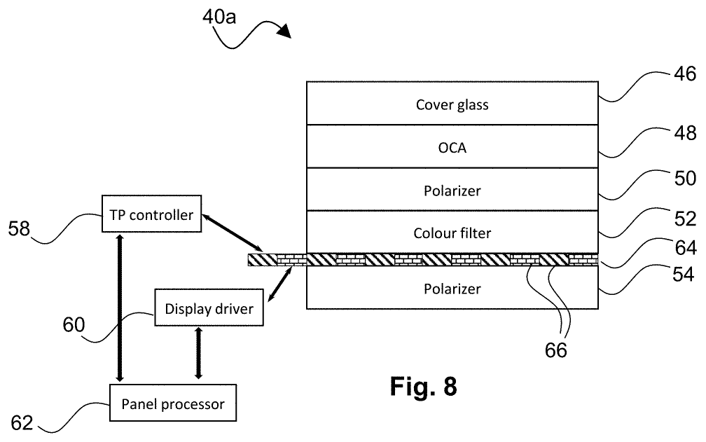

Preferably for the in-situ amplification performed in the present invention, as shown in the configuration of an LCD based display system 40a of FIG. 8, the display and touch sensor functionality may be integrated into a common layer 64 within the display system. This configuration is referred to an in-cell configuration in that all the components of the touch panel are integrated into the same substrate as the display circuitry, with which the touch panel shares space. The common display and touch sensor layer 64 may include individual elements 66 that are controllable by either the touch panel controller 58 or display driver 60 as desired for a given control function, including different function and sense modes.

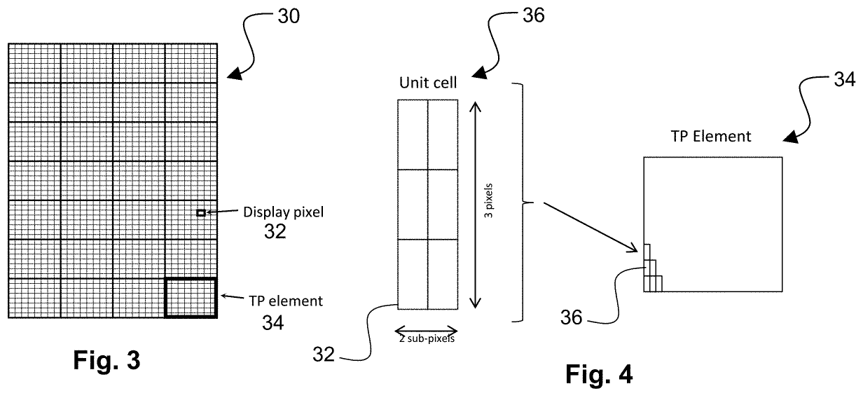

A pixel arrangement for an integrated display and touch sensor may be comparable as described above with respect to FIG. 3. Referring again to FIG. 3, the pixel arrangement 30 may include individual pixels 32 that are grouped into touch panel elements 34 that permit the touch panel and display operations. In a typical display, each pixel has a top electrode, and the pixel top electrodes combine into a single, continuous top electrode referred to as VCOM. For AMTP, the VCOM is patterned into a two-dimension array of touch panel elements 34. Each touch panel element covers a number of pixels, and the top electrode of these pixels is a component of the respective touch panel element. In this manner, therefore, the display and touch panel share the VCOM electrode.

The integrated display and touch sensor further may include an exemplary AMTP structure comparably as described above with respect to FIG. 4. Referring again to FIG. 4, in such configuration a basic unit cell 36 includes a plurality of the individual pixels 32 arranged in an array. In the example of FIG. 4, a basic unit cell 36 may include a 3×2 pixel array. The touch panel element 34 in turn includes an array of unit cells 36 arranged in parallel. A typical example may incorporate 100 unit cells 36 within a touch panel element 34, resulting in 600 individual pixels per touch panel element. As further detailed below, different sized unit cells may be advantageous with incorporation of the referenced amplifier circuitry of the present invention, and thus a unit cell need not be a 3×2 pixel array. For example, a 3×3 or other sized pixel array may be employed and is described below in connection with FIG. 14.

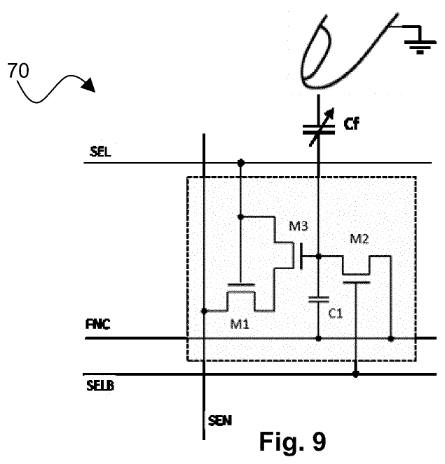

FIG. 9 is a drawing depicting functional circuitry for a unit cell 70, including integrated amplifier circuitry in accordance with embodiments of the present invention. Such configuration shares some elements with the AMTP elements described in WO 2017/056500. The unit cell 70 can be connected either to a sense line (SEN) or to a function line (FNC). These connections are made by two thin film transistors (TFTs), denoted M1 and M2. Gate select lines SEL and SELB are operable to switch M1 versus M2 open or closed, thereby controlling whether the unit cell 70 is connected to SEN (via operation of the SEL gate line) or to FNC (via operation of the SELB gate line). Referring back to FIG. 8, the SEN lines connect to the sensing circuitry of the touch panel controller (TPC) 58, so that touch signals can be read and measured. The FNC lines can either supply a driving signal from the display driver 60 for display functions, or can be connected to ground or other potential for performing different functions of the pixels.

As referenced above, the present disclosure describes enhancements to the unit cell of an active matrix touch panel (AMTP) by incorporating integrated amplifier circuitry that amplifies touch signals received in-situ. To amplify the touch signals, integrated amplifier circuitry includes a capacitor C1 and third TFT M3 that are added to the functional circuitry of the unit cell 70. In this example, the TFTs M1 and M2 are n-type digital switch TFTs that are rendered in an on state by application of a high gate voltage (digital “1” state) and off by a low or zero gate voltage (digital “0” state). M3 is an analogue TFT the current through which is dependent upon the gate voltage. Accordingly, to performing sensing, a first select line SEL for sensing is taken high to turn on M1, while a second select line for display functions SELB is taken low to turn off M2. With such operation, the sense line SEN becomes electrically connected to the unit cell, and the function line FNC becomes electrically disconnected from the unit cell.

Generally, therefore, an aspect of the invention is an enhanced touch panel having integrated amplifier circuitry for amplifying sense signals that are read during a sense mode. In exemplary embodiments, a touch panel includes a plurality of touch panel elements that are operable in a sense mode and a function mode, each touch panel element comprising an array of unit cells; wherein each unit cell comprises: a pixel array including a plurality of pixels arranged in rows and columns; a first transistor M1 that is connected at a first M1 terminal to a sense line (SEN) and at a gate of the first transistor to a first select line (SEL); a second transistor M2 that is connected at a first M2 terminal to a function line (FNC) and at a gate of the second transistor to a second select line (SELB); and amplifier circuitry that is integrated into the unit cell. During a function mode the second transistor is placed in an on state by a control signal from the SELB line to electrically connect the unit cell to the FNC line, and the first transistor is in an off state to electrically disconnect the first transistor from the SEN line. During the sense mode the first transistor is placed in an on state by a control signal from the SEL line to electrically connect the unit cell to the SEN line, and the second transistor is in an off state to electrically disconnect the second transistor from the FNC line; and the amplifier circuitry amplifies a sense signal that flows through the first transistor to the SEN line when the unit cell is in the sense mode.

Referring to FIG. 9, in exemplary embodiments the amplifier circuitry includes the third transistor M3 and the least one capacitor C1 that are integrated into the unit cell. A first plate of the capacitor is connected to the FNC line and a second plate of the capacitor is connected to a gate of the third transistor M3, wherein a potential at the gate of the third transistor M3 is determined by a potential divider formed by the capacitor and a capacitance of an object being sensed by the touch panel. The second plate of the capacitor C1 and the gate of the third transistor M3 are connected at a common node corresponding to the common electrode with a second M2 terminal of the second transistor M2. A first M3 terminal of the third transistor M3 is connected to the gate of the first transistor M1 and the SEL line, and a second M3 terminal of the third transistor M3 is connected to a second M1 terminal of the first transistor M1.

More particularly, the current through M3, and thus through M1 to the SEN line, is modulated by the potential at the gate of M3. The node at the gate of M3 further corresponds to the common electrode VCOM. The potential at the gate of M3 is determined by a potential divider formed by capacitor C1 and the capacitance of the object being sensed, represented by Cf. M3, therefore, as referenced above is configured as an amplifier such that the level of current through M3, and thus M1, will depend upon the level of the gate voltage that results from the potential divider. While in the sense mode, the FNC line is set to a suitable potential (e.g., ground) to place M3 at a convenient operation point for amplification of the touch signal. The difference in impedance related to Cf and C1 changes with the distance of the sensed object to the unit cell. As the sensed object gets closer to the unit cell, the impedance change perturbs the potential at the gate of M3. As the potential at the gate of M3 becomes perturbed with the presence of the sensed object, the resultant potential at the gate of M3 generates a current through M3 that is indicative of the presence of the sensed object, permitting an amplified sensing current to flow through M1 to the SEN line. In this manner, the presence of the object being sensed is detected with enhanced precision due to the amplification provided by the operation of C1 and M3. In the absence of the object being sensed, the potential at the gate of M3 is related only to the charge stored on the capacitor C1 without being perturbed by the presence of the sensed object, and the current flowing through M1 to the SEN line is indicative of the absence of the object.

To perform a drive function, the first select line SEL for sensing is taken low to turn off M1, while the second select line for display functions SELB is taken high to turn on M2. With such operation, the function line FNC becomes electrically connected to the common electrode, and the sense line SEN becomes electrically disconnected from the common electrode. With the FNC line electrically connected, a drive signal can be applied to the common electrode, for example to function as drive electrode in a mutual capacitance configuration, or in a first stage of a self-capacitance mode.

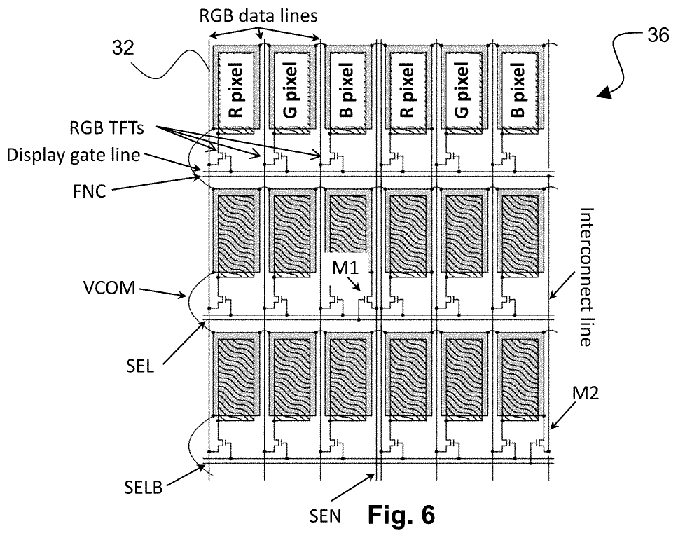

To perform a display function, the first select line SEL for sensing is taken low to turn off M1, while the second select line for display functions SELB is taken high to turn on M2. With such operation, the function line FNC becomes electrically connected to the common electrode, and the sense line SEN becomes electrically disconnected from the unit cell. The FNC line can then be connected to perform its display role of common ground electrode (VCOM). The FNC line could also be connected to other values of potential to perform other display functions unrelated to sensing. In typical operation, the display will emit an image and then idle while the display is refreshed. There may be an idle time between approximately 4 ms and 16 ms during which the display system data would be refreshed. During this refresh period, the display pixels are left inactive (for example, by taking the display gate line low, see FIG. 6), so that there is no interference between display and touch functions. Accordingly, sensing is performed without any recognizable effect on the display functionality.

In the described example, the TFTs M1, M2, and M3 are n-type TFTs as referenced above. Such a configuration may be preferred for power efficiency, although the TFTs could be configured as p-type transistors with the control signal operations adjusted as warranted to achieve the sensing and display functionality described above.

Another aspect of the invention is a method of operating a touch panel having integrated amplifier circuitry within the touch panel elements for amplifying a sense signal in-situ within the touch panel. In exemplary embodiments, the method includes the steps of: providing a touch panel including a plurality of touch panel elements that are operable in a sense mode and a function mode, each touch panel element comprising an array of unit cells that include amplifier circuitry integrated into each unit cell; operating a first portion of the touch panel elements in a function mode by electrically connecting said first portion of the touch panel elements to a function line FNC; operating a second portion of the touch panel elements in a sense mode by electrically connecting said second portion of the touch panel elements to a sense line SEN, wherein sense signals are read from the SEN line to detect a presence or absence of an object being sensed that operates the touch panel; and switching touch panel elements between being in the first portion of the touch panel elements operating in the function mode and the second portion of the touch panel elements operating in the sense mode to read sense signals across the touch panel; wherein the amplifier circuitry amplifies sense signals that flow to the SEN from the second portion of touch panel elements that are operating in the sense mode.

In exemplary embodiments, the touch panel may be operated in a mutual capacitance mode whereby a first portion of touch panel elements are operating in the function mode, with a drive signal applied to the FNC line, simultaneously while the second portion of touch panel elements are operating in the sense mode. The touch panel further may be operated in a self-capacitance mode including the steps of: first operating a chosen set of touch panel elements in the function mode and setting them to a set voltage level; and sequentially operating the same set of touch panel elements in the sense mode to read the sense signals from the touch panel elements. The touch panel may be switched between operating the touch panel in the mutual capacitance mode and the self-capacitance mode.

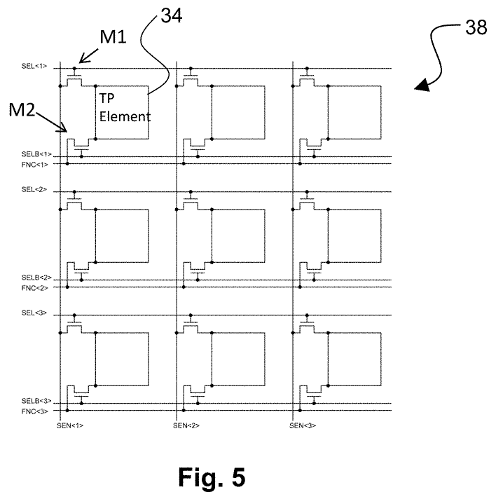

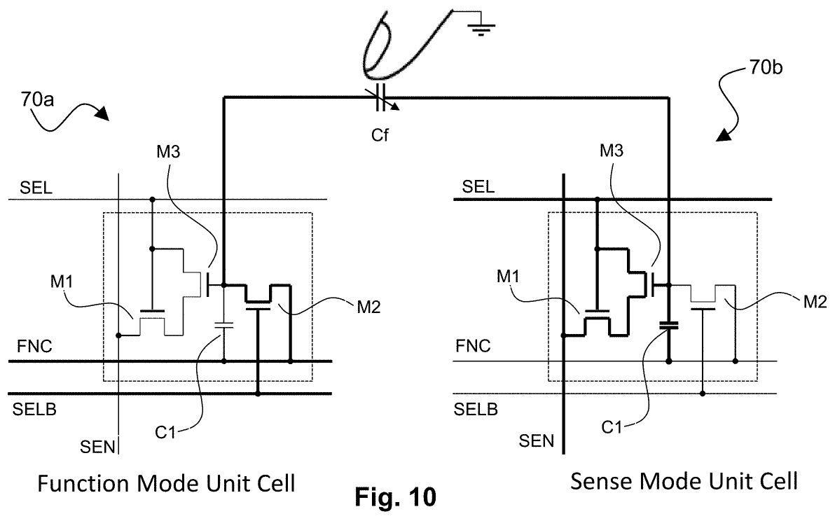

FIG. 10 is a drawing depicting a plurality of unit cells 70a and 70b each generally having the configuration of FIG. 9, and further illustrating operation in a mutual capacitance mode. The bolded line portions indicate the presence of control signal “on” states and resulting current flow, and the non-bolded line portions indicate control “off” states and the absence of any current flow. Generally for the mutual capacitance mode, the first unit cell 70a is operated in a function mode while the second unit cell 70b is operated in a sense mode. Although FIG. 10 depicts only two unit cells, it will be appreciated that an array of unit cells would be assembled into multiple touch panel elements for a display system, comparably as depicted for example in FIGS. 3 and 5.

As to the unit cell 70a in the function mode (left portion of FIG. 10), the second select line SELB is taken high to turn on M2, and the first select line SEL is taken low to turn off M1. As a result, the unit cell 70a is connected to the function line FNC so as to place the unit cell in any suitable functional mode (e.g., by connecting the unit cell 70a to a drive signal or to ground). During the function mode, a driving signal may be applied to the common electrode through transistor M2. This signal can couple capacitively to the second unit cell 70b. This capacitance coupling can be altered by the presence or absence of an object to be sensed.

As to the unit cell 70b in the sense mode (right portion of FIG. 10), the first select line SEL is taken high to turn on M1, and the second select line SELB is taken low to turn off M2. As a result, the unit cell 70b is connected to the sense line SEN. The gate potential of M3 is determined by the potential divider formed by C1 and the coupling capacitance Cf between touch element 70a and 70b. The potential of the FNC line can be adjusted to a suitable value to set M3 to a convenient operation point. Changes in Cf induce changes on the gate potential of M3, which in turn dictate the current flowing through M3. This current then flows through M1, which is in low impedance mode, and down the SEN line into the touch panel controller. Again, the unit cell 70b is operating in the sense mode simultaneously as the unit cell 70a is operating in the function mode.

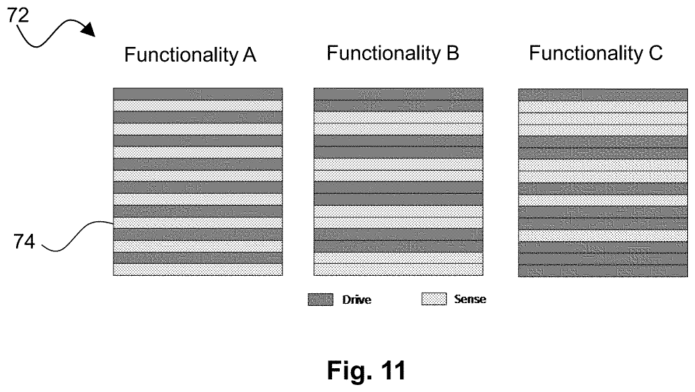

FIG. 11 is a drawing depicting functionality for implementing driving and sensing for a mutual capacitance mode within an active matrix touch panel 72. In an exemplary AMTP configuration that corresponds to the functionality of FIG. 11, the function lines FNC run horizontally and the sense lines SEN run vertically. Generally, with such a configuration, function mode signals are applied to those unit cells that are connected to the FNC lines, i.e., in the function mode as illustrated in the left portion of FIG. 10. With the FNC lines running horizontally, the AMTP panel 72 can be driven row-wise only. Sense signals are collected from those cells connected to the SEN lines, i.e., in the sensing mode as illustrated in the right portion of FIG. 10. With the SEL lines running horizontally, the cells in sensing mode are selected row-wise. The panel can be read to collect the sense signals in column-wise only, as SEN lines run vertically.

In the example of FIG. 11, the AMTP panel 72 includes rows 74 that contain the unit cells. Different shading as indicated is illustrative of a row being in the function mode versus a sense mode. The function mode signals may be different for different rows depending upon the input data from the display controller, and may be a “0” signal corresponding to the FNC line being connected to ground. Referring to FIG. 11 in combination with FIG. 10, the rows in the function mode also are in a state in which their common electrodes are connected to the FNC lines. On a row basis, the select lines SEL are actuated to collect the sensing signal from unit cells within rows in the sensing mode, the signal collection occurring in a column-wise direction. FIG. 11 depicts exemplary row selection patterns that may be employed to achieve the described functionality. In Functionality A, row selection for driving versus sensing is implemented by alternating rows. In Functionality B, row selection for driving versus sensing is implemented by alternating two rows. Any suitable row selection pattern may be employed, as illustrated for example by the row selection pattern of Functionality C.

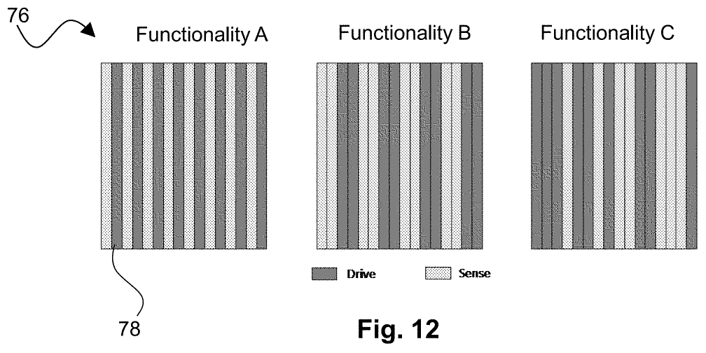

FIG. 12 is a drawing depicting an alternative functionality for implementing function and sense modes within an active matrix touch panel 76 based on selection via columns 78. With such configuration, the role of FNC and SEL lines could be interchanged, such that the AMTP panel can be driven column-wise, and sensing signals are read row-wise only. Similarly as with row-based operation, any suitable column selection pattern may be employed as illustrated by the different patterns of Functionality A, Functionality B, and Functionality C of FIG. 12.

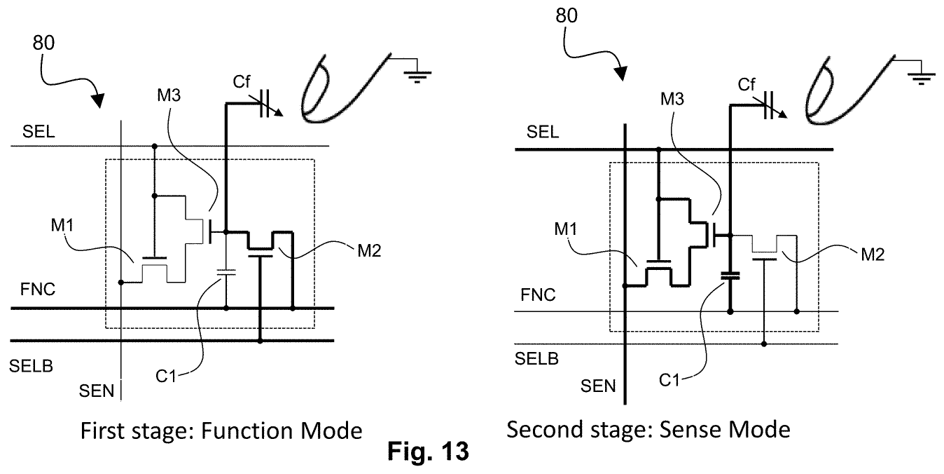

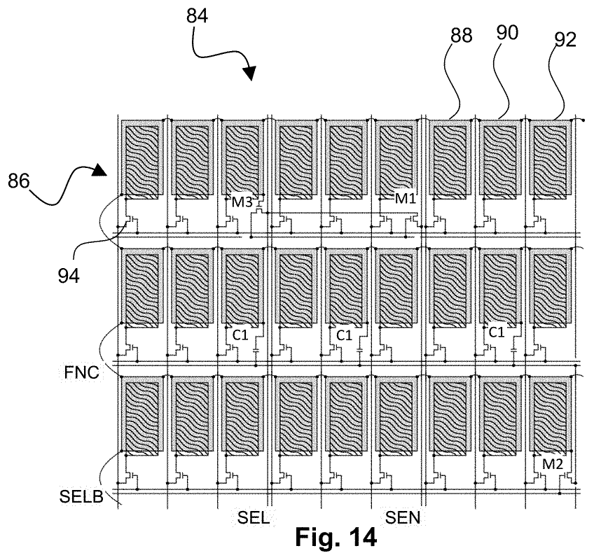

In contrast with the operation described with respect to FIG. 10, FIG. 13 is a drawing depicting a unit cell 80 generally having the configuration of FIG. 9, and further illustrating operation in a self-capacitance mode. The bolded line portions again indicate the presence of control signal “on” states and resulting current flow, and the non-bolded line portions indicate control “off” states and the absence of any current flow. Generally for the self-capacitance mode, the unit cell 80 is operated sequentially in a first stage corresponding to the function mode during which a the common electrode is set to a given voltage via the FNC line and M2 (left side portion of FIG. 13), and next in a second stage corresponding to the sense mode during which sense signals are collected or read from the unit cells (right side portion of FIG. 13). Although FIG. 13 depicts only one unit cell in function and sense stages corresponding to the two different modes, it will be appreciated that an array of unit cells would be assembled into multiple touch panel elements for a display system, comparably as depicted for example in FIGS. 3 and 5.

When the unit cell 80 is in the function mode (left portion of FIG. 13), the second select line SELB is taken high to turn on M2, and the first select line SEL is taken low to turn off M1. As a result, the unit cell 80 is connected to the function line FNC so as to place the unit cell in any suitable functional mode (e.g., by connecting the unit cell 80 to a drive signal or to ground). During the function mode, current flowing through transistor M2 sets the common electrode to a chosen voltage level, thus requiring the injection of a certain amount of charge depending on Cf.

When the unit cell 80 is in the sense mode (right portion of FIG. 13), the first select line SEL is taken high to turn on M1, and the second select line SELB is taken low to turn off M2. As a result, the unit cell 80 is connected to the sense line SEN to collect and read a sense signal from the common electrode of unit cell 80. As described above, the resultant potential at the gate of M3 depends upon the potential divider generated by the presence or absence of an object to be sensed (Cf) and C1. During the sense mode, the potential at the gate of M3 determines a current level through M3, and therefore M1, to generate the sense signal through the sense line SEN.

For the self-capacitance mode, all chosen elements are sensed independently relative to each other. The driving and sensing operations are performed sequentially. Looking at the exemplary AMTP panel such as shown in FIG. 11, the elements of the dark rows are set to drive function mode (FIG. 13 left). Then, the elements of the dark rows are set to the second stage corresponding to the sense mode, and the sense signals are read sequentially column-wise until all the dark rows are sensed. The clear rows are ignored during these two stages by having their SEL and SELB lines at a low state. The touch panel device may be switched between mutual capacitance and self-capacitance modes by operation of the control elements, as may be suitable for detecting the object to be sensed in particular circumstances.

FIG. 14 is a drawing depicting an exemplary LCD implementation of a unit cell 84 in combination with associated pixel elements, in accordance with embodiments of the present invention. As referenced above, Applicant's commonly owned WO 2017/056500 describes an exemplary unit cell configured as a 3×2 pixel array, as depicted for example in FIG. 6 herein. For incorporation of the additional amplifier circuitry, including amplifying components capacitor C1 and TFT M3, the unit cell 84 of FIG. 14 is configured as a 3×3 pixel array of individual pixels 86. A 3×3 pixel array provides a suitable configuration for incorporation of the components of the amplifier circuitry. Each pixel 86 may include first, second, and third sub-pixels 88, 90, and 92 respectively. The three sub-pixels may correspond to color sub-pixels for red, green, and blue light emission. Each sub-pixel further may include a drive transistor 94 for controlling light emission from the respective sub-pixel based on control signals received from the display driver (see FIG. 3).

For illustration purposes, FIG. 14 may be considered in combination with the more generalized depiction of the unit cell of FIG. 9. Following the circuit pathways of FIG. 14 (and as shown in FIG. 9), the gate of M1 is connected to the first select line SEL, and the gate of M2 is connected to the second select line SELB. The select lines are selectively operated to connect the unit cell either to the function line FNC through M2, or to the sense line SEN through M1, as described above. The SEL and SEN lines are vertical, and the SELB and FNC lines are horizontal, in this configuration with the associated positioning of the amplifier circuitry components C1 and M3. As described above, the current through M1 in the sense mode is controlled by the potential at the gate of M3, which is based on the potential divider resulting from the charges at the capacitors C1 in combination with the capacitance of an object to be sensed when present. Integrated capacitors may require substantial valuable space in the circuit substrate. To avoid space problems, a capacitor can be divided into smaller portions connected in parallel. In this particular example, the capacitance for the amplifier circuitry components is distributed over three pixels via the three capacitors C1 connected in parallel.

The enhanced unit cell of the various embodiments of touch panel elements thus includes integrated amplifier circuitry that amplifies touch signals received by the touch panel element in-situ, i.e., the amplifier circuitry is integrated into the touch panel unit cells such that touch signals are amplified within the unit cells before transmission to the touch panel controller. This integrated amplification improves the signal-to-noise ratio (SNR). The additional amplifier circuitry components are incorporated into the unit cell circuitry without having to add any additional signal control lines, which provides for enhanced touch panel sensing without significant increase in the complexity to the overall unit cell configuration.

An aspect of the invention, therefore, is an enhanced touch panel having integrated amplifier circuitry for amplifying sense signals that are read during a sense mode. In exemplary embodiments, a touch panel includes a plurality of touch panel elements that are operable in a sense mode and a function mode, each touch panel element comprising an array of unit cells. Each unit cell includes: a pixel array including a plurality of pixels arranged in rows and columns; a first transistor M1 that is connected at a first M1 terminal to a sense line (SEN) and at a gate of the first transistor to a first select line (SEL); a second transistor M2 that is connected at a first M2 terminal to a function line (FNC) and at a gate of the second transistor to a second select line (SELB); and amplifier circuitry that is integrated into the unit cell. During a function mode the second transistor is placed in an on state by a control signal from the SELB line to electrically connect the unit cell to the FNC line, and the first transistor is in an off state to electrically disconnect the first transistor from the SEN line. During the sense mode the first transistor is placed in an on state by a control signal from the SEL line to electrically connect the unit cell to the SEN line, and the second transistor is in an off state to electrically disconnect the second transistor from the FNC line; and the amplifier circuitry amplifies a sense signal that flows through the first transistor to the SEN line when the unit cell is in the sense mode. The touch panel may include one or more of the following features, either individually or in combination.

In an exemplary embodiment of the touch panel, the amplifier circuitry comprises a third transistor M3 and at least one capacitor that are integrated into the unit cell.

In an exemplary embodiment of the touch panel, a first plate of the capacitor is connected to the FNC line and a second plate of the capacitor is connected to a gate of the third transistor M3, wherein a potential at the gate of the third transistor M3 is determined by a potential divider formed by the capacitor and a capacitance of an object being sensed by the touch panel.

In an exemplary embodiment of the touch panel, the second plate of the capacitor and the gate of the third transistor connect at a common node with a second M2 terminal of the second transistor M2.

In an exemplary embodiment of the touch panel, a first M3 terminal of the third transistor M3 is connected to the gate of the first transistor M1 and the SEL line, and a second M3 terminal of the third transistor M3 is connected to a second M1 terminal of the first transistor M1, such that the sense signal modulated by the potential at the gate of the third transistor M3 flows through the first transistor M1 to the SEN line.

In an exemplary embodiment of the touch panel, the at least one capacitor comprises a plurality of capacitors connected in parallel that are distributed among the plurality of pixels.

In an exemplary embodiment of the touch panel, the plurality of capacitors comprises three capacitors connected in parallel.

In an exemplary embodiment of the touch panel, each unit cell includes a 3×3 array of pixels.

In an exemplary embodiment of the touch panel, each pixel includes red, blue, and green sub-pixels.

Another aspect of the invention is a display system that includes a touch panel that is operable in a sense mode and a function mode according to any of the embodiments wherein the plurality of touch panel elements are arranged in an array of rows and columns; a touch panel controller that generates control signals for operation of the touch panel and reads sense signals generated by the touch panel during the sense mode; and a display driver that generates control signals for display functionality when the touch panel is in the function mode. Display and touch functionality may be integrated into a common layer within the display system to form an in-cell touch panel.

Another aspect of the invention is a method of operating a touch panel having integrated amplifier circuitry within the touch panel elements for amplifying a sense signal in-situ within the touch panel. In exemplary embodiments, the method includes the steps of: providing a touch panel including a plurality of touch panel elements that are operable in a sense mode and a function mode, each touch panel element comprising an array of unit cells that include amplifier circuitry integrated into each unit cell; operating a first portion of the touch panel elements in a function mode by electrically connecting said first portion of the touch panel elements to a function line FNC; operating a second portion of the touch panel elements in a sense mode by electrically connecting said second portion of the touch panel elements to a sense line SEN, wherein sense signals are read from the SEN line to detect a presence or absence of an object being sensed that operates the touch panel; and switching touch panel elements between being in the first portion of the touch panel elements operating in the function mode and the second portion of the touch panel elements operating in the sense mode to read sense signals across the touch panel; wherein the amplifier circuitry amplifies sense signals that flow to the SEN line from the second portion of touch panel elements that are operating in the sense mode. The method may include one or more of the following features, either individually or in combination.

In an exemplary embodiment of the method of operating a touch panel, the amplifier circuitry includes a capacitor, with one terminal connected to the FNC line, and the other terminal connected to the common electrode.

In an exemplary embodiment of the method of operating a touch panel, the amplifier circuitry further comprises a transistor, and the sense signal is based on a potential at a gate of the transistor as determined by a potential divider formed by the capacitor and a capacitance of common electrode to its environment.

In an exemplary embodiment of the method of operating a touch panel, the touch panel is operated in a mutual capacitance mode whereby the first portion of touch panel elements are operating in the function mode simultaneously while the second portion of touch panel elements is operating in the sense mode.

In an exemplary embodiment of the method of operating a touch panel, the touch panel further is operated in a self-capacitance mode including the steps of: first operating all touch panel elements in the function mode to charge the common electrode to a specified voltage; and sequentially operating the touch panel elements in the sense mode to read the amplified sense signals from the touch panel elements until sense signals are read for the entire touch panel.

In an exemplary embodiment of the method of operating a touch panel, the method further includes switching between operating the touch panel in the mutual capacitance mode and the self-capacitance mode.

In an exemplary embodiment of the method of operating a touch panel, the first and second portions of the touch panel elements are selected on a row basis; and sense signals are read from the second portion of the touch panel elements on a column basis.

In an exemplary embodiment of the method of operating a touch panel, the first and second portions of the touch panel elements are selected on a column basis; and sense signals are read from the second portion of the touch panel elements on a row basis.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

The present invention has applicability to touch panel devices, and in particular to capacitive type touch panel devices. Such capacitive type touch panel devices may find application in a range of consumer electronic products including, for example, mobile phones, tablet, laptop and desktop PCs, electronic book readers and digital signage products.

### REFERENCE SIGNS LIST

10—transparent substrate
11—sensing electrode
12—voltage source
13—input object
14—capacitor
15—current sensor
20—drive electrode
21—sense electrode
22—voltage source
23—mutual coupling capacitor
24—current measurement device
27—drive electrode
28—sense electrode
30—pixel arrangement
32—individual pixels
34—touch panel (TP) elements
36—basic unit cell
38—exemplary array
40—LCD display system
40a—LCD display system
42—touch panel
44—display
46—cover glass
48—optically clear adhesive (OCA) layer
50—front polarizer
52—color filter
54—rear polarizer
58—touch panel controller
60—display driver
62—main panel processor
64—common display and touch sensor layer
66—individual elements of common display and touch sensor layer
70—exemplary unit cell
70a—first unit cell
70b—second unit cell
72—active matrix touch panel
74—rows of unit cells
76—active matrix touch panel
78—columns of unit cells
80—self-capacitance unit cell
84—unit cell showing pixel arrangement
86—individual pixels
88—first sub-pixel
90—second sub-pixel
92—third sub-pixel
94—drive transistor
M1—first transistor
M2—second transistor
M3—third transistor
C1—capacitor
SEL—first select line(s)
SELB—second select line(s)
SEN—sense line(s)
FNC—function line(s)

1. A touch panel comprising:
a plurality of touch panel elements that are operable in a sense mode and a function mode, each touch panel element comprising an array of unit cells;
wherein each unit cell comprises:
a pixel array including a plurality of pixels arranged in rows and columns;
a first transistor M1 that is connected at a first M1 terminal to a sense line (SEN) and at a gate of the first transistor to a first select line (SEL);
a second transistor M2 that is connected at a first M2 terminal to a function line (FNC) and at a gate of the second transistor to a second select line (SELB); and
amplifier circuitry that is integrated into the unit cell;
and wherein:
during a function mode the second transistor is placed in an on state by a control signal from the SELB line to electrically connect the unit cell to the FNC line, and the first transistor is in an off state to electrically disconnect the first transistor from the SEN line;
wherein during the sense mode the first transistor is placed in an on state by a control signal from the SEL line to electrically connect the unit cell to the SEN line, and the second transistor is in an off state to electrically disconnect the second transistor from the FNC line; and
the amplifier circuitry amplifies a sense signal that flows through the first transistor to the SEN line when the unit cell is in the sense mode.

2. The touch panel of claim 1, wherein the amplifier circuitry comprises a third transistor M3 and at least one capacitor that are integrated into the unit cell.

3. The touch panel of claim 2, wherein a first plate of the capacitor is connected to the FNC line and a second plate of the capacitor is connected to a gate of the third transistor M3, wherein a potential at the gate of the third transistor M3 is determined by a potential divider formed by the capacitor and a capacitance of an object being sensed by the touch panel.

4. The touch panel of claim 3, wherein the second plate of the capacitor and the gate of the third transistor connect at a common node with a second M2 terminal of the second transistor M2.

5. The touch panel of claim 3, wherein a first M3 terminal of the third transistor M3 is connected to the gate of the first transistor M1 and the SEL line, and a second M3 terminal of the third transistor M3 is connected to a second M1 terminal of the first transistor M1, such that the sense signal modulated by the potential at the gate of the third transistor M3 flows through the first transistor M1 to the SEN line.

6. The touch panel of claim 3, wherein the at least one capacitor comprises a plurality of capacitors connected in parallel that are distributed among the plurality of pixels.

7. The touch panel of claim 6, wherein the plurality of capacitors comprises three capacitors connected in parallel.

8. The touch panel of claim 1, wherein each unit cell includes a 3×3 array of pixels.

9. The touch panel of claim 1, wherein each pixel includes red, blue, and green sub-pixels.

10. A display system comprising:
a touch panel that is operable in a sense mode and a function mode according to claim 1, wherein the plurality of touch panel elements are arranged in an array of rows and columns;
a touch panel controller that generates control signals for operation of the touch panel and reads sense signals generated by the touch panel during the sense mode; and
a display driver that generates control signals for display functionality when the touch panel is in the function mode.

11. The display system of claim 10, wherein display and touch functionality are integrated into a common layer within the display system to form an in-cell touch panel.

12. A method of operating a touch panel comprising:
providing a touch panel including a plurality of touch panel elements that are operable in a sense mode and a function mode, each touch panel element comprising an array of unit cells that include amplifier circuitry integrated into each unit cell;
operating a first portion of the touch panel elements in a function mode by electrically connecting said first portion of the touch panel elements to a function line FNC;
operating a second portion of the touch panel elements in a sense mode by electrically connecting said second portion of the touch panel elements to a sense line SEN, wherein sense signals are read from the SEN line to detect a presence or absence of an object being sensed that operates the touch panel; and
switching touch panel elements between being in the first portion of the touch panel elements operating in the function mode and the second portion of the touch panel elements operating in the sense mode to read sense signals across the touch panel;
wherein the amplifier circuitry amplifies sense signals that flow to the SEN from the second portion of touch panel elements that are operating in the sense mode.

13. The method of operating a touch panel of claim 12, wherein the amplifier circuitry includes a capacitor, with one terminal connected to the FNC line, and the other terminal connected to the common electrode.

14. The method of operating a touch panel of claim 13, wherein the amplifier circuitry further comprises a transistor, and the sense signal is based on a potential at a gate of the transistor as determined by a potential divider formed by the capacitor and a capacitance of common electrode to its environment.

15. The method of operating a touch panel of claim 12, wherein the touch panel is operated in a mutual capacitance mode whereby the first portion of touch panel elements are operating in the function mode simultaneously while the second portion of touch panel elements is operating in the sense mode.

16. The method of operating a touch panel of claim 15, wherein the touch panel further is operated in a self-capacitance mode including the steps of:
first operating all touch panel elements in the function mode to charge the common electrode to a specified voltage; and
sequentially operating the touch panel elements in the sense mode to read the amplified sense signals from the touch panel elements until sense signals are read for the entire touch panel.

17. The method of operating a touch panel of claim 16, further comprising switching between operating the touch panel in the mutual capacitance mode and the self-capacitance mode.

18. The method of operating a touch panel of claim 12, wherein:
the first and second portions of the touch panel elements are selected on a row basis; and
sense signals are read from the second portion of the touch panel elements on a column basis.

19. The method of operating a touch panel of claim 12, wherein:
the first and second portions of the touch panel elements are selected on a column basis; and
sense signals are read from the second portion of the touch panel elements on a row basis.
